(19) United States
(12) Patent Application Publication
(10) Pub. No.: US 2018/0315361 A1
(43) Pub. Date: Nov. 1, 2018

(54) HEAD-UP DISPLAY DEVICE

(71) Applicant: DENSO CORPORATION, Kariya-city, Aichi-pref. (JP)

(72) Inventors: Kazuhisa ONDA, Kariya-city (JP); Hiroshi ANDO, Kariya-city (JP)

(21) Appl. No.: 15/769,466

(22) PCT Filed: Jun. 8, 2016
(86) PCT No.: PCT/JP2016/002774

§ 371 Date: Apr. 19, 2018

(30) Foreign Application Priority Data
Oct. 22, 2015 (JP) 2015-207878

(51) Int. Cl. G09G 3/00; B60K 35/00; G02B 27/01

(52) U.S. Cl. CPC G09G 3/002; B60K 35/00; G02B 27/0101; G02B 2027/012; B60K 2350/2047; G09G 2380/10; B60K 2350/2052

(57) ABSTRACT

A scanning unit scans laser light emitted from a laser light emitting unit. A condensing lens condenses the laser light scanned with the scanning unit and forms a beam. A screen forms the display image thereon upon incidence of the beam formed with the condensing unit. A projection unit projects the display image formed on the screen onto the display member. The screen includes a micromirror array or a microlens array. When the beam is incident on any point of the micromirror array or the microlens array, two or more components forming the micromirror array or the microlens array overlap with a spot of the beam. When a center of the beam and a center of any component among the components are matched, a center of a neighboring component next to the component of interest is outside the spot of the beam.

### CROSS REFERENCE TO RELATED APPLICATION

This application is based on Japanese Patent Application No. 2015-207878 filed on Oct. 22, 2015, the disclosure of which is incorporated herein by reference.

### TECHNICAL FIELD

The present disclosure relates to a head-up display device.

### BACKGROUND ART

A known head-up display device forms a virtual image of a display image, which is visible from eyepoints of a driver, by projecting the display image onto a windshield of a vehicle. The head-up display device includes a screen, on which a display image is formed upon incidence of a beam, a concave mirror, which magnifies and projects the display image onto the windshield, and the like.

As described in Patent Literature 1, a micromirror array or a microlens array is used as a screen. The micromirror array and the microlens array are capable of magnifying an eyebox by diffusing a beam incident on the screen.

### PRIOR TECHNICAL LITERATURE

### Patent Literature

Patent Literature 1: JP-A-2014-235268

Multi-slit interference and non-uniform luminance possibly occur in the eyebox when the micromirror array or the microlens array is used as the screen.

### SUMMARY OF INVENTION

It is an object of the present disclosure to provide a head-up display device capable of restricting multi-slit interference and non-uniform luminance in an eyebox.

According to one aspect of the present disclosure, a head-up display device is to project a display image onto a display member and to form a virtual image of a display image visible from a pre-set visible region. The head-up display device comprises: a laser light emitting unit to emit laser light; a scanning unit to scan the laser light emitted from the laser light emitting unit; a condensing lens to form a beam by condensing the laser light scanned with the scanning unit; a screen to form the display image thereon upon incidence of the beam formed with the condensing unit; and a projection unit to project the display image formed on the screen onto the display member. The screen includes a micromirror array or a microlens array satisfying the following conditions J1 and J2.

J1: when the beam is incident on any point of the micromirror array or the microlens array, two or more components forming the micromirror array or the microlens array overlap with a spot of the beam.

J2: when a center of the beam and a center of any component among the components are matched, a center of a neighboring component next to the component of interest is outside the spot of the beam.

According to the configuration as above, multi-slit interference and non-uniform luminance in an eyebox can be restricted.

### BRIEF DESCRIPTION OF THE DRAWINGS

The above and other objects, features and advantages of the present disclosure will become more apparent from the following detailed description made with reference to the accompanying drawings. In the drawings:

The above and other objects, configurations, and advantages of the present disclosure will become more apparent from the following detailed description taken in conjunction with the accompanying drawings, in which:

FIG. 1 is an explanatory view showing a configuration of a head-up display device 1;

FIG. 2 is an explanatory view showing a configuration of a screen 9;

FIG. 3 is an explanatory view showing a relationship of a diameter of a beam B and a size of a micromirror 15 when a condition J2 is satisfied;

FIG. 4 is an explanatory view showing a relationship of the diameter of the beam B and the size of the micromirror 15 when the condition J2 is not satisfied;

FIG. 5 is view used to describe a luminance distribution in an eyebox 27 when a condition J1 is satisfied;

FIG. 6 is an explanatory view showing a luminance distribution in the eyebox 27 when the condition J1 is not satisfied;

FIG. 7 is an explanatory view showing a configuration of a head-up display device 101;

FIG. 8 is an explanatory view showing a configuration of a screen 109;

FIG. 9 is an explanatory view showing a shape and an array of micromirrors 15 according to another embodiment;

FIG. 10 is an explanatory view showing a shape and an array of micromirrors 15 according to still another embodiment;

FIG. 11 is an explanatory view showing a shape and an array of micromirrors 15 according to yet another embodiment;

FIG. 12 is an explanatory view showing a shape and an array of micromirrors 15 according to a further modification;

FIG. 13 is an explanatory view showing a shape and an array of micromirrors 15 according to a still further embodiment; and

FIG. 14 is an explanatory view showing a shape and an array of micromirrors 15 according to a yet further embodiment.

### DESCRIPTION OF EMBODIMENTS

Embodiments of the present disclosure will be described with reference to the drawings.

### First Embodiment

1. Configuration of Head-Up Display Device 1

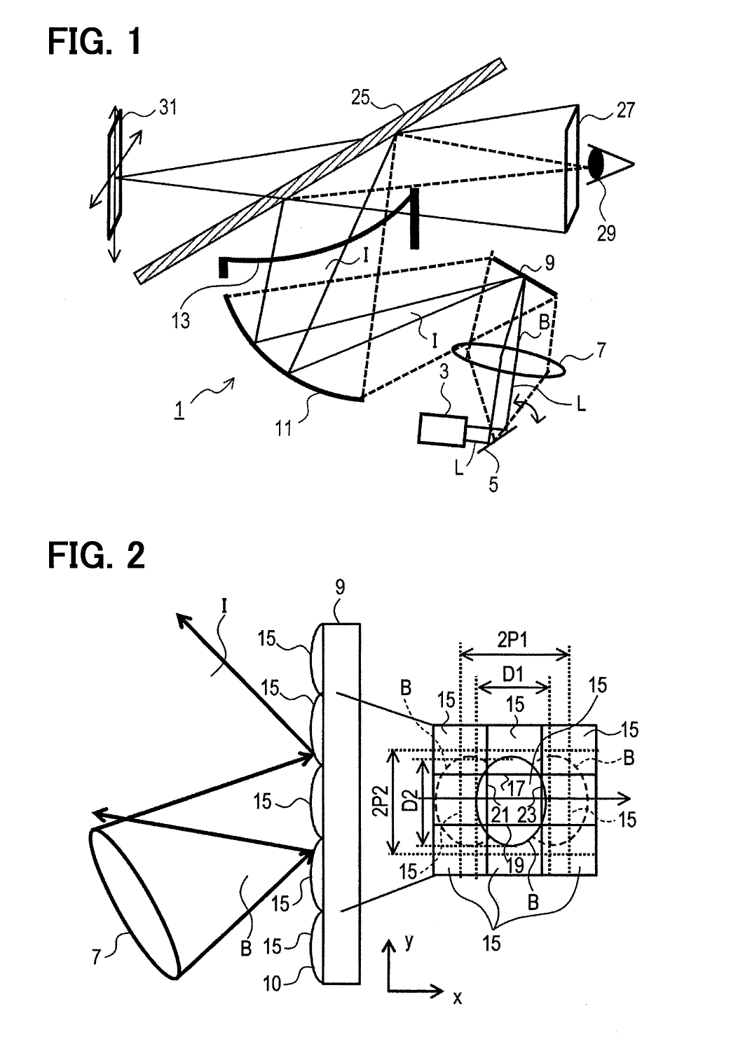

The configuration of a head-up display device 1 will be described with reference to FIG. 1 and FIG. 2. The head-up display device 1 is provided in a dashboard of a vehicle.

The head-up display device 1 includes a laser light emitting unit 3, a scanning unit 5, a condensing unit 7, a screen 9, a magnifying mirror 11, and a shield 13.

The laser light emitting unit 3 emits laser light L. The scanning unit 5 is a MEMS scanner. MEMS stands for a micro-electro-mechanical system. The scanning unit 5 is located on a light path of laser light L emitted from the laser light emitting unit 3. The scanning unit 5 scans laser light L by tilting a mirror surface of the MEMS scanner. A display image is formed on the screen 9 by scanning of laser light L. The scanning unit 5 conjugates with a pupil 29 of a driver described below.

The condensing unit 7 is an optical element having a convex lens effect. The condensing unit 7 is formed by combining optical elements, such as a convex lens, a concave lens, a convex mirror, and a concave mirror. The condensing lens 7 is located on a light path of laser light L scanned with the scanning unit 5. The condensing lens 7 forms a beam B by condensing laser light L. The condensing unit 7 is furnished with a function of forming an image by focusing the beam B on the screen 9.

The beam B formed with the condensing unit 7 goes incident on the screen 9. A display image is formed on the screen 9 by scanning the beam B. As is shown in FIG. 2, the screen 9 includes a micromirror array 10. The micromirror array 10 is made of regularly arrayed multiple micromirrors 15. The micromirrors 15 correspond to components. The screen 9 reflects and diffuses the beam B by using the micromirrors 15.

Each micromirror 15 is in a rectangular shape. The rectangular shape corresponds to a polygonal shape having two opposing parallel sides and corresponds to a quadrangular shape. A scan direction of the beam B on the screen 9 is given as a direction x. The direction orthogonal to the direction x on the screen 9 is given as a direction y. The micromirror 15 has two opposing sides 17 and 19 parallel to the direction x. The micromirror 15 also has two opposing sides 21 and 23 parallel to the direction y.

A condition J1 and a condition J2 as follows are satisfied for the screen 9.

J1: when the beam B is incident on any point of the screen 9, two or more micromirrors 15 overlap with a spot of the beam B.

J2: when the center of the beam B and the center of any micromirror 15 are matched, the center of a neighboring micromirror 15 next to the micromirror 15 of interest is outside the spot of the beam B.

The spot of the beam B represents a size of the beam B up to which beam intensity is at or above 1/e² of peak intensity. The center of the beam B represents the center of the spot of the beam B. The neighboring micromirror 15 represents a micromirror 15 next to the micromirror 15 of interest, the center of which coincides with the center of the beam B.

A relationship as follows is established between the screen 9 and the beam B. That is, a beam diameter D1 given as below is not less than one time and less than two times a pitch P1 given as follows. In addition, a beam diameter D2 given as follows is not less than one time and less than two times a pitch P2 given as follows. The beam diameter D1 may be 1 to 1.8 times the pitch P1. The beam diameter D2 may be 1 to 1.8 times the pitch P2.

Beam diameter D1: a diameter of the beam B in a direction orthogonal to the side 21 and the side 23.

Pitch P1: a center-to-center pitch of the micromirrors 15 in the direction orthogonal to the side 21 and the side 23.

Beam diameter D2: the diameter of the beam B in a direction orthogonal to the side 17 and the side 19.

Pitch P2: a center-to-center pitch of the micromirrors 15 in the direction orthogonal to the side 17 and the side 19.

The center-to-center pitch of the micromirrors 15 represents a center-to-center distance between two neighboring micromirrors 15. In the present embodiment, the pitch P1 and the pitch P2 are different. However, the pitch P1 and the pitch P2 may be equal.

The magnifying mirror 11 is a concave mirror. The magnifying mirror 11 is located on a light path of light which is the beam B reflected on the screen 9. Light reflected on the screen 9 is display light I of a display image formed on the screen 9. The magnifying mirror 11 projects the display image onto a windshield 25 by reflecting the display light I in a direction toward the windshield 25. The windshield 25 corresponds to a display member. The magnifying mirror 11 is a concave mirror, and therefore, the display image projected onto the windshield 25 is magnified with respect to the display image on the screen 9. The shield 13 is formed of a transparent member and transmits the display light I. The magnifying mirror 11 corresponds to a projection unit.

When the windshield 25 is seen from the pupil 29 of the driver within a pre-set eyebox 27, the display image appears as a visible virtual image 31 ahead of the vehicle. The eyebox 27 corresponds to a visible region. The visible region represents a region within which the virtual image 31 is visible.

2. Effects Attained with Head-Up Display Device 1

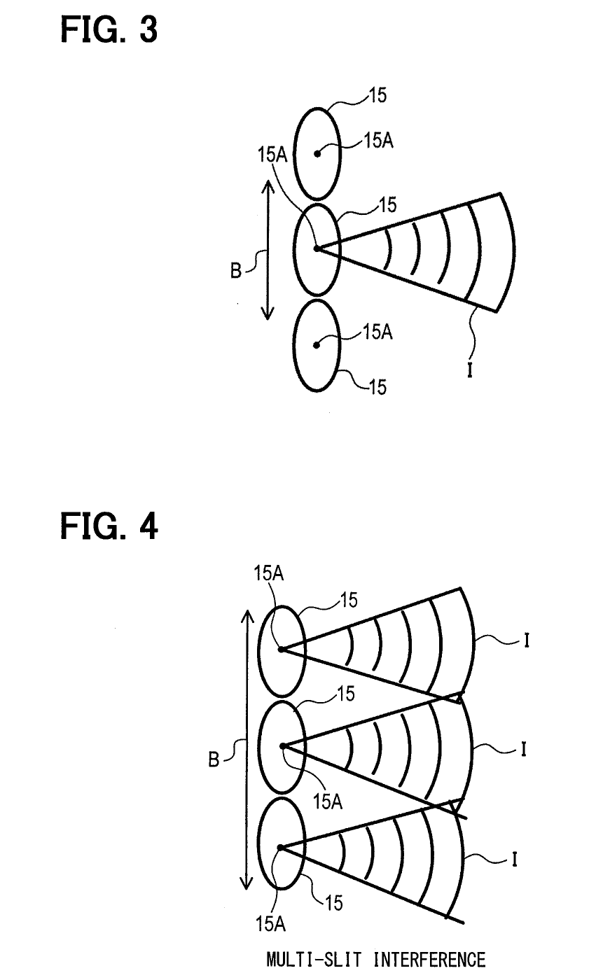

(1A) In the head-up display device 1, the condition J2 is satisfied. Hence, as is shown in FIG. 3, the beam B is less likely to fall on centers 15A of two or more micromirrors 15 at a time. Consequently, multi-slit interference of the display light I reflected on the screen 9 can be restricted.

To the contrary, when the condition J2 is not satisfied, as is shown in FIG. 4, the beam B falls on the centers 15A of two or more micromirrors 15 at a time, and the display light I is emitted from the respective two or more micromirrors 15. In this case, multi-slit interference of the display light I occurs.

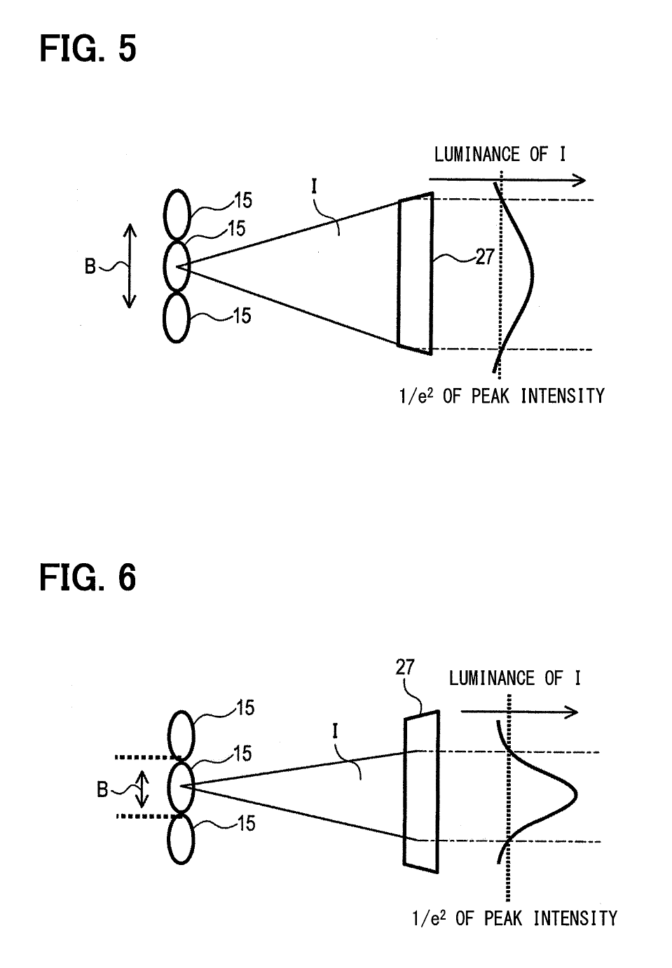

(1B) In the head-up display device 1, the condition J1 is satisfied. Hence, as is shown in FIG. 5, the beam B goes incident on the micromirror 15 over a sufficiently wide range. Consequently, uniformness of luminance of the display light I can be enhanced over a wide range in the eyebox 27. In short, non-uniform luminance in the eyebox 27 can be restricted.

To the contrary, when the condition J1 is not satisfied, as is shown in FIG. 6, the beam B goes incident on the micromirror 15 only in a limited range. Consequently, it becomes difficult to enhance uniformness of luminance of the display light I over a wide range in the eyebox 27.

(1C) In the head-up display device 1, the beam diameter D1 is less than two times the pitch P1, and the beam diameter D2 is less than two times the pitch P2. Hence, the beam B is further less likely to fall on the centers 15A of two or more micromirrors 15 at a time. Consequently, multi-slit interference of the display light I reflected on the screen 9 can be restricted further.

In a case where the beam diameter D1 is not greater than 1.8 times the pitch P1 and the beam diameter D2 is not greater than 1.8 times the pitch P2, the effect as above becomes further noticeable.

(1D) In the head-up display device 1, the beam diameter D1 is not less than one time the pitch P1, and the beam diameter D2 is not less than one time the pitch P2. Hence, the beam B goes incident on the micromirror 15 over a further wider range. Consequently, uniformness of luminance of the display light I can be enhanced over a further wider range in the eyebox 27. In short, non-uniform luminance in the eyebox 27 can be restricted further.

(1E) The micromirrors 15 are in a rectangular shape. Hence, the structure of the screen 9 can be simpler.

### Second Embodiment

A second embodiment is same as the first embodiment above in fundamental configuration, will chiefly describe a difference, and will omit a description of common configurations. Numeral references same as numeral references used in the first embodiment above denote same configurations and reference should be made to the description in the first embodiment above.

1. Configuration of Head-Up Display Device 101

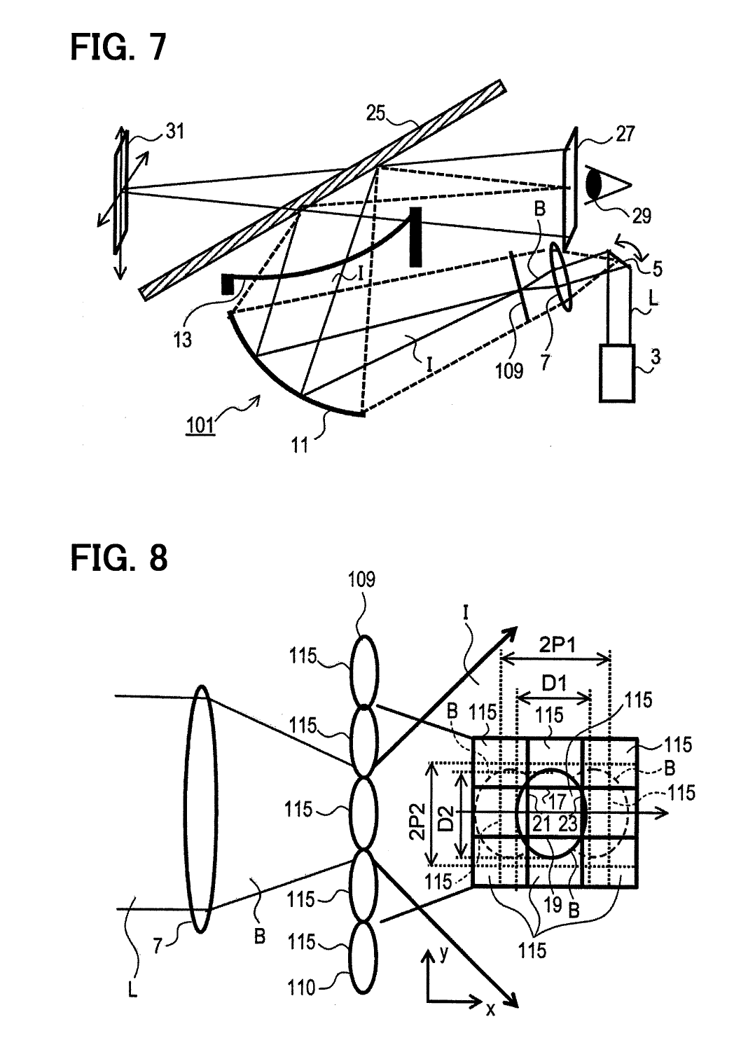

A configuration of a head-up display device 101 will be described with reference to FIG. 7 and FIG. 8. The head-up display device 101 is provided in a dashboard of a vehicle.

The head-up display device 101 includes a laser light emitting unit 3, a scanning unit 5, a condensing unit 7, a screen 109, a magnification mirror 11, and a shield 13.

The laser light emitting unit 3, the scanning unit 5, and the condensing unit 7 are the same as the counterparts in the first embodiment above.

The beam B formed with the condensing unit 7 goes incident on the screen 109. A display image is formed on the screen 109 by scanning the beam B. As is shown in FIG. 8, the screen 109 includes a microlens array 110. The microlens array 110 is made of regularly arrayed multiple microlenses 115. The microlenses 115 correspond to components. The screen 109 diffuses and transmits the beam B by using the microlenses 115.

Each microlens 115 is in a rectangular shape. A rectangular shape corresponds to a polygonal shape having two opposing parallel sides and corresponds to a quadrangular shape. A scan direction of the beam B on the screen 109 is given as the direction x. A direction orthogonal to the direction x on the screen 109 is given as the direction y. The microlens 115 has two opposing sides 17 and 19 parallel to the direction x. The microlens 115 also has two opposing sides 21 and 23 parallel to the direction y.

A condition J1 and a condition J2 as follows are satisfied for the screen 109.

J1: when the beam B is incident on any point of the screen 109, two or more microlenses 115 overlap with the spot of the beam B.

J2: when the center of the beam B and the center of any microlens 115 are matched, the center of a neighboring microlens 115 next to the microlens 115 of interest is outside the spot of the beam B.

A relationship as follows is established between the screen 109 and the beam B. That is, the beam diameter D1 given as below is not less than one time and less than two times a pitch P1 given as follows. In addition, the beam diameter D2 given as follows is not less than one time and less than two times a pitch P2 given as follows. The beam diameter D1 is preferably 1 to 1.8 times the pitch P1. The beam diameter D2 is preferably 1 to 1.8 times the pitch P2.

Beam diameter D1: the diameter of the beam B in the direction orthogonal to the side 21 and the side 23.

Pitch P1: a center-to-center pitch of the microlenses 115 in the direction orthogonal to the side 21 and the side 23.

Beam diameter D2: the diameter of the beam B in the direction orthogonal to the side 17 and the side 19.

Pitch P2: a center-to-center pitch of the microlenses 115 in the direction orthogonal to the side 17 and the side 19.

The center-to-center pitch of the microlenses 115 represents a center-to-center distance between two neighboring microlenses 115. In the present embodiment, the pitch P1 and the pitch P2 are different. However, the pitch P1 and the pitch P2 may be equal.

The magnifying mirror 11 is a concave mirror. The magnifying mirror 11 is located on a light path of light which is the beam B passing through the screen 109. Light which has passed through the screen 109 is display light I of a display image formed on the screen 109. The magnifying mirror 11 projects the display image onto the windshield 25 by reflecting the display light I in a direction toward the windshield 25. Because the magnifying mirror 11 is a concave mirror, the display image projected onto the windshield 25 is magnified with respect to the display image on the screen 109. The magnifying mirror 11 corresponds to a projection unit. The shield 13 is formed of a transparent member and transmits the display light I.

When the windshield 25 is seen from a pupil 29 of a driver within a pre-set eyebox 27, the display image appears as the visible virtual image 31 ahead of the vehicle. The eyebox 27 corresponds to the visible region.

2. Effects Attained with Head-Up Display Device 101

(2A) In the head-up display device 101, the condition J2 is satisfied. Hence, the beam B is less likely to fall on centers of two or more microlenses 115 at a time. Consequently, multi-slit interference of the display light I passing through the screen 109 can be restricted.

(2B) In the head-up display device 101, the condition J1 is satisfied. Hence, the beam B goes incident on the microlens 115 over a sufficiently wide range. Consequently, uniformness of luminance of the display light I can be enhanced over a wide range in the eyebox 27. In short, non-uniform luminance in the eyebox 27 can be restricted.

(2C) In the head-up display device 101, the beam diameter D1 is less than two times the pitch P1, and the beam diameter D2 is less than two times the pitch P2. Hence, the beam B is further less likely to fall on centers of two or more microlenses 115 at a time. Consequently, multi-slit interference of the display light I passing through the screen 109 can be restricted further.

In a case where the beam diameter D1 is not greater than 1.8 times the pitch P1, and the beam diameter D2 is not greater than 1.8 times the pitch P2, the effect as above becomes further noticeable.

(2D) In the head-up display device 101, the beam diameter D1 is not less than one time the pitch P1, and the beam diameter D2 is not less than one time the pitch P2. Hence, the beam B goes incident on the microlens 115 over a further wider range. Consequently, uniformness of luminance of the display light I can be enhanced over a further wider range in the eyebox 27. In short, non-uniform luminance in the eyebox 27 can be restricted further.

(2E) The microlenses 115 are in a rectangular shape. Hence, the structure of the screen 109 can be simpler.

### Other Embodiments

While the above has described the embodiments carrying out the present disclosure, the present disclosure is not limited to the embodiments above and can be modified in various manners.

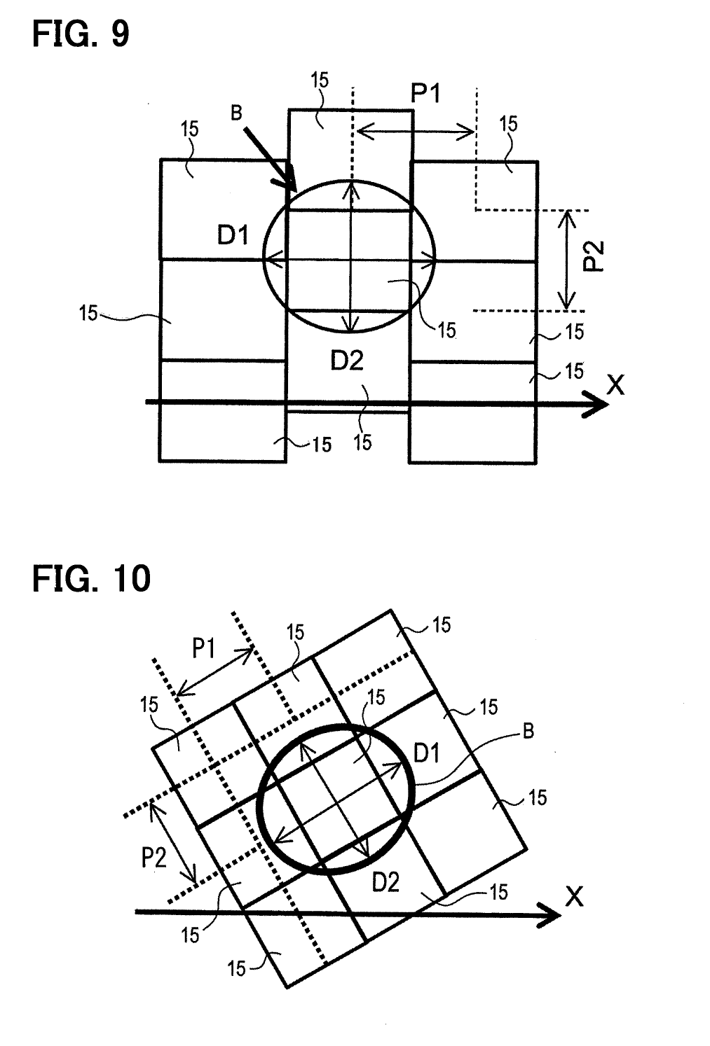

(1) The screen 9 of the first embodiment above may be modified in any one of manners shown in FIG. 9 through FIG. 14.

In an embodiment shown in FIG. 9, a micromirror 15 is in a rectangular shape. The micromirrors 15 are tightly arrayed. The micromirrors 15 are arrayed in a straight line along the direction y. In any two micromirrors 15 neighboring in the direction x, those positions of centers in the direction y do not match.

In the embodiment shown in FIG. 9, definitions of pitches P1 and P2 and beam diameters D1 and D2 are the same as the definitions of the first embodiment above. The beam diameter D1 is not less than one time and not greater than 1.8 times the pitch P1, and the beam diameter D2 is not less than one time and not greater than 1.8 times the pitch P2. The pitch P1 is larger than the pitch P2.

The effects (1A) through (1E) above can be attained also in a case where the screen 9 of the embodiment shown in FIG. 9 is used.

In an embodiment shown in FIG. 10, micromirrors 15 are in a square shape. The micromirrors 15 are arrayed tightly. The micromirrors 15 have two sets of two opposing parallel sides. The two opposing parallel sides in both of the two sets are inclined with respect to the direction x and the direction y.

In the embodiment shown in FIG. 10, definitions of pitches P1 and P2 and beam diameters D1 and D2 are the same as the definitions of the first embodiment above. Then, the beam diameter D1 is not less than one time and not greater than 1.8 times the pitch P1, and the beam diameter D2 is not less than one time and not greater than 1.8 times the pitch P2. The pitch P1 and the pitch P2 are equal.

The effects (1A) through (1E) above can be attained also in a case where the screen 9 of the embodiment shown in FIG. 10 is used.

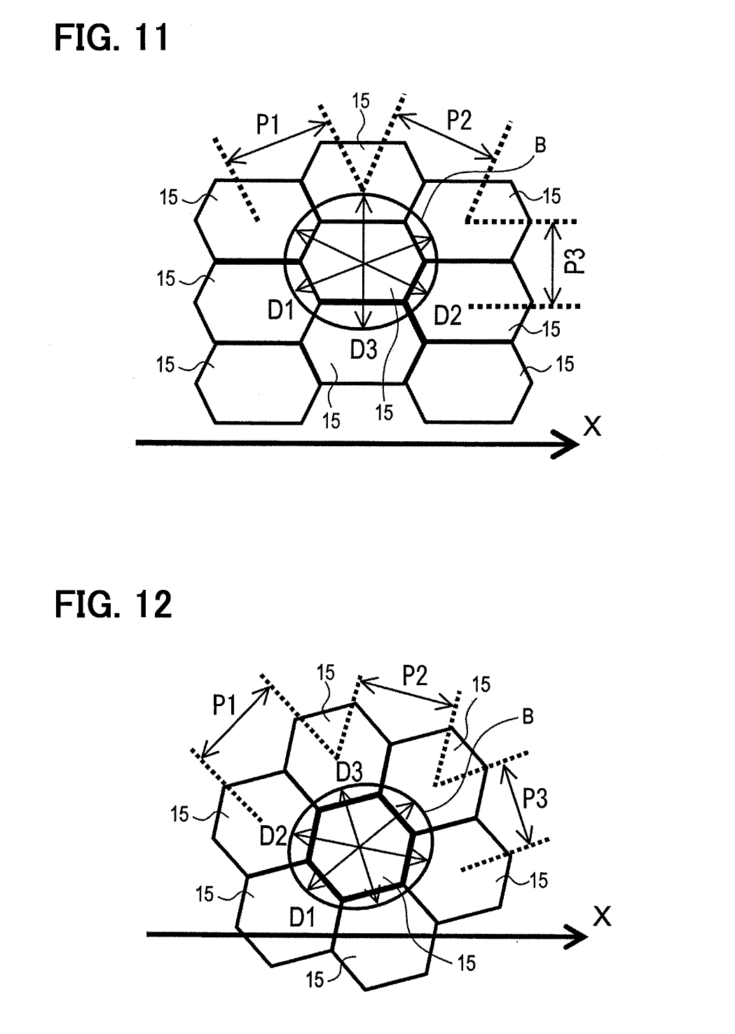

In an embodiment shown in FIG. 11, micromirrors 15 are in a hexagonal shape. In the hexagonal shape of FIG. 11, two sides at top and bottom are longer than the other four sides. The micromirrors 15 are arrayed tightly. The micromirrors 15 have three sets of two opposing parallel sides.

Let P1 through P3 be center-to-center pitches of the micromirrors 15 in directions orthogonal to the two opposing parallel sides in the respective three sets. In addition, the diameter of the beam B in a direction corresponding to the pitch P1 is given as the beam diameter D1, the diameter of the beam B in a direction corresponding to the pitch P2 is given as the beam diameter D2, and the diameter of the beam B in a direction corresponding to the pitch P3 is given as a beam diameter D3. The beam diameter D1 is not less than one time and not greater than 1.8 times the pitch P1, the beam diameter D2 is not less than one time and not greater than 1.8 times the pitch P2, and the beam diameter D3 is not less than one time and not greater than 1.8 times the pitch P3. The pitch P1 and the pitch P2 are equal. The pitch P1 and the pitch P2 are larger than the pitch P3.

The effects (1A) through (1D) above can be attained also in a case where the screen 9 of the embodiment shown in FIG. 11 is used.

An embodiment shown in FIG. 12 is fundamentally same as the embodiment shown in FIG. 11 except that micromirrors 15 in the embodiment shown in FIG. 12 are in a regular hexagonal shape. That is, pitches P1, P2, and P3 are all equal.

The effects (1A) through (1D) above can be attained also in a case where the screen 9 of the embodiment shown in FIG. 12 is used.

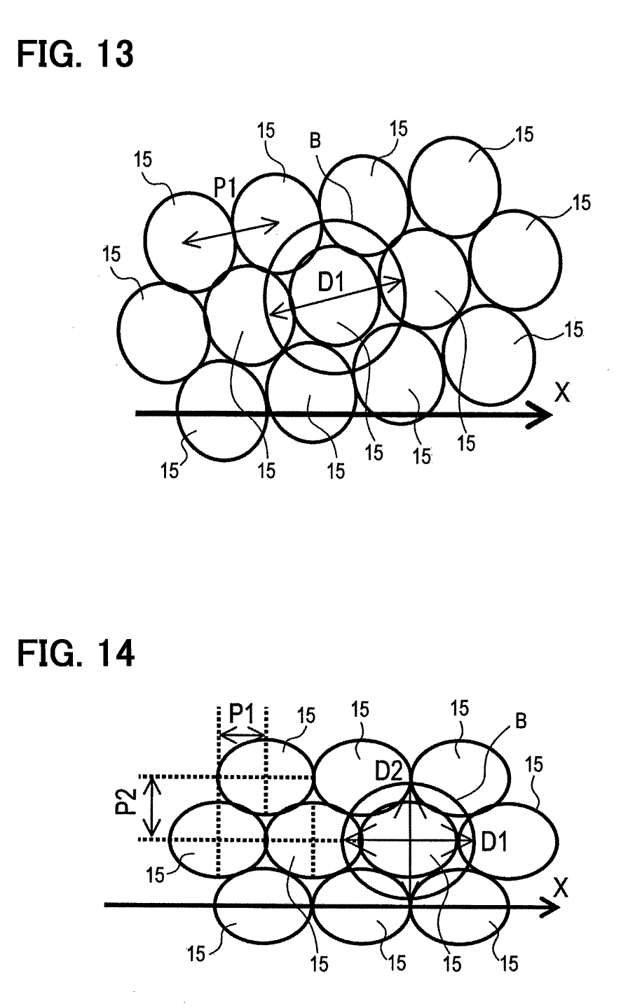

In an embodiment shown in FIG. 13, micromirrors 15 are in a circular shape. Micromirrors 15 are arrayed densely to array a maximum number of the micromirrors 15 per unit area.

Consider any two neighboring micromirrors 15. Let P1 be a center-to-center pitch of the two micromirrors 15. The diameter of the beam B in a measurement direction of the pitch P1 is given as the beam diameter D1. Then, the beam diameter D1 is not less than one time and not greater than 1.8 times the pitch P1.

The effects (1A) through (1D) above can be attained also in a case where the screen 9 of the embodiment shown in FIG. 13 is used.

In an embodiment shown in FIG. 14, micromirrors 15 are in an elliptical shape. The micromirrors 15 are arrayed densely to array a maximum number of the micromirrors 15 per unit area. Long axes of the micromirrors 15 are parallel to the direction x, and short axes are parallel to the direction y. The micromirrors 15 are arrayed by aligning the long axes in a straight line along the direction x.

Consider two micromirrors 15 having a shortest center-to-center distance. Let P1 be a center-to-center pitch of the two micromirrors 15 in a long axis direction, and P2 be a center-to-center pitch in a short axis direction. In addition, let D1 be the diameter of the beam B in the long axis direction, and D2 be the diameter in the short axis direction. The beam diameter D1 is not less than one time and not greater than 1.8 times the pitch P1, and the beam diameter D2 is not less than one time and not greater than 1.8 times the pitch P2. The pitch P1 is larger than the pitch P2.

The effects (1A) through (1D) above can be attained also in a case where the screen 9 of the embodiment shown in FIG. 14 is used.

(2) In the second embodiment above, the screen 109 may be modified in the same manner as any one of the manners shown in FIG. 9 through FIG. 14. That is, microlenses 115 forming a screen 109 may be of a shape same as any one of the shapes of the micromirrors 15 in FIG. 9 through FIG. 14 and arrayed in same manners. Effects same as the effects of the second embodiment above can be attained also in a case where screen 109 in any one of the embodiments of FIG. 9 through FIG. 14 is used.

(3) In the embodiments above, the windshield 25 is used as the display member. However, the display member is not limited to the windshield 25. For example, the display member may be a glass plate provided separately from the windshield 25.

(4) A function furnished to a single constituent element in the embodiments above may be allocated to more than one constituent element or functions furnished to two or more constituent elements may be collectively furnished to a single constituent element. A part of the configurations of the embodiments above may be omitted. At least a part of the configurations of the embodiments above may be added to or replaced with the configurations of the other embodiments. Any manner included in a technical idea specified only by languages described in the scope of claims below is an embodiment of the present disclosure.

(5) Besides the head-up display devices described above, the present disclosure can be realized in various forms, such as a system including the head-up display devices as a constituent element, a program causing a computer to function as the head-up display devices, a non-transient tangible recording medium, such as a semiconductor memory, which has recorded the program, and an image display method.

While the present disclosure has been described according to the embodiments above, it should be understood that the present disclosure is not limited to the embodiments above and structures thereof. The present disclosure includes various modifications and alterations within the equivalent scope. In addition, various combinations and embodiments, as well as other combinations further including one element alone and more or less than one element are also within the scope and the idea of the present disclosure.

What is claimed is:

1. A head-up display device to project a display image onto a display member and to form a virtual image of a display image visible from a pre-set visible region, comprising:
a laser light emitting unit to emit laser light;
a scanning unit to scan the laser light emitted from the laser light emitting unit;
a condensing lens to form a beam by condensing the laser light scanned with the scanning unit;
a screen to form the display image thereon upon incidence of the beam formed with the condensing unit; and
a projection unit to project the display image formed on the screen onto the display member, wherein
the screen includes a micromirror array or a microlens array,
when the beam is incident on any point of the micromirror array or the microlens array, two or more components forming the micromirror array or the microlens array overlap with a spot of the beam, and
when a center of the beam and a center of any component among the components are matched, a center of a neighboring component next to the component of interest is outside the spot of the beam.

2. The head-up display device according to claim 1, wherein
the components are in a polygonal shape having two opposing parallel sides, and
a beam diameter D is not less than one time and less than two times a pitch P, where the beam diameter D is a diameter of the beam in a direction orthogonal to the two opposing parallel sides, and the pitch P is a center-to-center pitch of the components in a direction orthogonal to the two opposing parallel sides.

3. The head-up display device according to claim 2, wherein
the beam diameter D is 1 to 1.8 times the pitch P.

4. The head-up display device according to claim 2, wherein
the polygonal shape is a quadrangular shape or a hexagonal shape.

5. The head-up display device according to claim 2, wherein
the pitch P is same for any two opposing parallel sides.

6. The head-up display device according to claim 1, wherein
the components are in a circular shape, and
a beam diameter D is not less than one time and less than two times a pitch P, where the beam diameter D is a diameter of the beam in a measurement direction of the pitch P, and the pitch P is a center-to-center pitch of the components.

7. The head-up display device according to claim 6, wherein
the beam diameter D is 1 to 1.8 times the pitch P.

8. The head-up display device according to claim 1, wherein
the components are in an elliptical shape, and
a beam diameter D1 is not less than one time and less than two times a pitch P1 and a beam diameter D2 is not less than one time and less than two times a pitch P2, where the beam diameter D1 is a diameter of the beam in a long axis direction of the elliptical shape, the pitch P1 is a center-to-center pitch of the components in the long axis direction, the beam diameter D2 is a diameter of the beam in a short axis direction of the elliptical shape, and the pitch P2 is a center-to-center pitch of the components in the short axis direction.

9. The head-up display device according to claim 8, wherein
the beam diameter D1 is 1 to 1.8 times the pitch P1, and the beam diameter D2 is 1 to 1.8 times the pitch P2.
